(19) United States
(12) Patent Application Publication
(10) Pub. No.: US 2010/0053656 A1
(43) Pub. Date: Mar. 4, 2010

(54) Image processing apparatus capable of processing color image, image processing method and storage medium storing image processing program

(75) Inventor: Yuko Oota, Osaka-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/585,001

(22) Filed: Aug. 31, 2009

(30) Foreign Application Priority Data
Sep. 2, 2008 (JP) 2008-224892

(51) Int. Cl. G06K 15/02

(52) U.S. Cl. 358/1.11; 358/1.18

(57) ABSTRACT

Given a circular graph that is divided by four colors (red, blue, yellow, and green), for example. This circular graph shows information indicated by the corresponding colors in accordance with planar dimensions of respective areas (e.g., a ratio of items corresponding to the respective colors to total and the like). Furthermore, the items corresponding to the respective colors are described as a legend independently of the circular graph. For example, since for people with protanopia/deuteranopia, “red” and “green” look the same, they cannot identify these colors. In image processing according to a first embodiment, the information indicated by the colors is added to a graph as shown in FIG. A to generate an image as shown in FIG. 1C.

This application is based on Japanese Patent Application No. 2008-224892 filed with the Japan Patent Office on Sep. 2, 2008, the entire content of which is hereby incorporated by reference.

### BACKGROUND OF THE INVENTION

1. Field of the Invention

This invention relates to an image processing apparatus capable of processing a color image, an image processing method and storage medium storing an image processing program, and particularly to a technique that provides a color universal design for people with impaired color vision.

2. Description of the Related Art

In recent years, the development of image formation technology has been promoting the shift of a printed material from monochrome to full color.

Meanwhile, it is said that there are three million or more people (about 5% in male, about 0.2% in female) with congenitally impaired color vision in Japan. It is considered that the more important information transmission in color is with an increase of color documents, the more often the information described in the documents is hard for the people with impaired color vision to read, or is misread by them. As a result, it is also considered that for the people with impaired color vision, the society has become more inconvenient than before.

For instance, when a plurality of people communicate with each other, such as in a conference or presentation, a graph that is divided by color is used routinely. In such a case, if discussion is brought forward among participants based on a color graph prepared without considering a CUD (Color Universal Design), in some cases, the people with impaired color vision cannot properly communicate with others.

As a more specific example, in the case where a circular graph that is divided by color and information indicated by the respective colors (legends) are described separately, the participants communicate with each other while a description is given, for example, saying “a red portion in the graph donates . . . , a green portion donates . . . ”. However, for example, since for people with protanopia/deuteranopia, “red” and “green” look the same color, in some cases, they cannot understand the information properly. As a result, it is considered that the people with impaired color vision often communicate with people with normal color vision while checking the description contents with them.

As one approach to solve the above-described problem, in Japanese Laid-Open Patent Publication No. 2005-51405, there is disclosed an image processing apparatus capable of conveying an equivalent amount of information to that of a color image to the people with impaired color vision without impairing a large amount of information by color and visual effects. In this image processing apparatus, patterns are inserted into colored portions of the graph to enable the people with impaired color vision to recognize a difference in color that is hard for them to distinguish.

However, in the graph obtained using the image processing apparatus disclosed in Japanese Laid-Open Patent Publication No. 2005-51405, respective elements included in the graph are distinguished by pattern. There is thus a problem in that if an area to which each of the patterns is assigned is not large enough, the elements cannot be sufficiently discriminated. Moreover, in some cases, the addition of the patterns may make the representation different from what a person with normal color vision who has prepared the graph intend for.

### SUMMARY OF THE INVENTION

This invention is achieved in order to solve the above-described problems, and an object thereof is to provide an image processing apparatus that enables smooth communication between people with normal color vision and people with impaired color vision to be realized, an image processing method of the same and a storage medium storing an image processing program for the same.

An image processing apparatus according to one aspect of the present invention includes a first extractor, a second extractor, a identifying unit, an identifying unit, a determining unit, and an output unit. The first extractor extracts, from an area excluding the graph area in the input image data, sets of color included in the area and a piece of information indicated by the color. The second extractor extracts, from an area excluding the graph area in the input image data, sets of color included in the area and a piece of information indicated by the color. The identifying unit identifies among graph elements included in the graph area, the graph element having the same color as each of the colors included in the extracted sets. The determining unit determines in which positions of the graph area the pieces of information, indicated by the respective colors that the identified graph elements have, are to be added. The output unit outputs output image data by adding the pieces of information indicated by the respective colors to the input image data, based on the determined positions.

Preferably, the second extractor searches a text area existing within a predetermined range with respect to the graph area in the input image data, and extracts a color included in the searched text area and a corresponding text image.

Preferably, the sets each include a color of a legend and a text image corresponding to the color of the legend.

Preferably, the output unit includes a generator for generating additional image data to be added to the input image data, and a synthesizer for synthesizing the input image data and the additional image data into the output image data. The generator generates the additional image data by arranging the text image in a position of the corresponding graph element.

Further preferably, the generator determines whether or not the text image can be arranged within an area of the corresponding graph element when a circular graph is included in the graph area. When the text image cannot be arranged within the area of the corresponding graph element, the generator arranges the text image outside the area of the corresponding graph element.

Further preferably, when the text image can be arranged within the area of the corresponding graph element, the generator changes a color of the text image to be arranged in accordance with the color of the graph element as the arrangement destination.

Further preferably, when a line graph is included in the graph area, the determining unit searches a start point and an end point of each of the graph elements, and a cross point between the graph elements, and determines at least one of the start point, the end point, and a point at a predetermined distance from the cross point, as an arrangement position of the corresponding text image.

An image processing method according to another aspect of the present invention includes the steps of: extracting a graph area from input image data; extracting, from an area excluding the graph area in the input image data, sets of color included in the area and a piece of information indicated by the color; identifying, among graph elements included in the graph area, the graph element having the same color as each of the colors included in the extracted set; determining a position where the piece of information, indicated by the respective colors that the identified graph elements have, are to be added in the graph area; and outputting output image data by adding the pieces of information indicated by the respective colors to the input image data, based on the determined positions.

Preferably, the step of extracting the sets includes the steps of: searching a text area existing within a predetermined range with respect to the graph area in the input image data, and extracting a color included in the searched text area and a corresponding text image.

Preferably, the sets each include a color of a legend and a text image corresponding to the color of the legend.

Preferably, the step of outputting includes the steps of: generating additional image data to be added to the input image data; and synthesizing the input image data and the additional image data into the output image data. The step of generating includes the step of generating the additional image data by arranging the text image in a position of the corresponding graph element.

Further preferably, the step of generating further includes the steps of: determining whether or not the text image can be arranged within an area of the corresponding graph element when a circular graph is included in the graph area; and arranging the text image outside the area of the corresponding graph element when the text image cannot be arranged within the area of the corresponding graph element.

Further preferably, the step of generating further includes the step of changing a color of the text image to be arranged in accordance with the color of the graph element as the arrangement destination, when the text image can be arranged within the area of the corresponding graph element.

Further preferably, when a line graph is included in the graph area, the step of determining includes the steps of: searching a start point and an end point of each of the graph elements, and a cross point between the graph elements; and determining at least one of the start point, the end point, and a point at a predetermined distance from the cross point, as an arrangement position of the corresponding text image.

According to a still another aspect of the present invention, the present invention provides a storage medium storing an image processing program. When the image processing program is executed by a processor, the image processing program causes the processor operative to: extract a graph area from input image data; extract from an area excluding the graph area in the input image data, sets of color included in the area and a piece of information indicated by the color; identify, among graph elements included in the graph area, the graph element having the same color as each of the colors included in the extracted set; determine a position where the piece of information, indicated by the respective colors that the identified graph elements have, are to be added in the graph area; and output output image data by adding the piece of information indicated by the respective colors to the input image data, based on the determined positions.

Preferably, extracting the sets includes: searching a text area existing within a predetermined range with respect to the graph area in the input image data, and extracting a color included in the searched text area and a corresponding text image.

Preferably, the sets each include a color of a legend and a text image corresponding to the color of the legend.

Preferably, the outputting includes: generating additional image data to be added to the input image data; and synthesizing the input image data and the additional image data into the output image data. The generating includes generating the additional image data by arranging the text image in a position of the corresponding graph element.

Further preferably, the generating further includes, determining whether or not the text image can be arranged within an area of the corresponding graph element when a circular graph is included in the graph area; and arranging the text image outside the area of the corresponding graph element when the text image cannot be arranged within the area of the corresponding graph element.

Further preferably, the generating further includes changing a color of the text image to be arranged in accordance with the color of the graph element as the arrangement destination, when the text image can be arranged within the area of the corresponding graph element.

Preferably, when a line graph is included in the graph area, the determining includes: searching a start point and an end point of each of the graph elements, and a cross point between the graph elements; and determining at least one of the start point, the end point, and a point a predetermined distance from the cross point, as an arrangement position of the corresponding text image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The application file contains at least one drawing executed in color. Copies of this patent or patent application publication with color drawings will be provided by the Office upon request and payment of the necessary fees.

FIGS. 1A to 1C are diagrams showing one example of image processing according to an embodiment of the present invention.

FIGS. 2A to 2C are diagrams showing another example of image processing according to the embodiment of the present invention.

FIG. 3 is a block diagram showing an apparatus configuration of an MFP (Multi Function Peripheral) according to a first embodiment of the present invention.

FIG. 4 is a block diagram showing a functional configuration relating to image processing in MFP according to the first embodiment of the present invention.

FIG. 5 is a flowchart showing an overall processing procedure of the image processing according to the first embodiment of the present invention.

FIG. 6 is a conceptual diagram of processing relating to step S4 in FIG. 5.

FIGS. 7A to 7C are diagrams for illustrating more detailed processing for extracting a graph area shown in FIG. 6.

FIG. 8 is a diagram for describing more detailed contents of expansion processing.

FIG. 9 is a flowchart showing a more detailed processing procedure relating to step S6 of the flowchart shown in FIG. 5.

FIGS. 10A to 10C are conceptual diagrams of extraction processing of a graph element.

FIG. 11 is a flowchart showing a more detailed processing procedure relating to step S8 of the flowchart shown in FIG. 5.

FIG. 12 is a structural diagram showing one example of correspondence relationships generated by processing of step S10 of the flowchart shown in FIG. 5.

FIGS. 13A and 13B are conceptual diagrams of processing for determining whether or not any character has been described in the graph element in advance.

FIGS. 14A to 14C are conceptual diagrams of processing for comparing a size of a text image to be added and a size of an area of the graph element.

FIGS. 15A and 15B are conceptual diagrams of processing for determining a color of the text image to be added.

FIG. 16 is a flowchart showing a more detailed processing procedure relating to step S12 of the flowchart shown in FIG. 5.

FIG. 17 is a flowchart showing another more detailed processing procedure (first modification) relating to step S12 of the flowchart shown in FIG. 5.

FIG. 18 is a conceptual diagram of processing for extracting graph elements included in the graph area.

FIG. 19 is a conceptual diagram of searching processing to the graph area including a line graph.

FIG. 20 is a flowchart showing a more detailed processing procedure relating to step S12 of the flowchart shown in FIG. 5.

FIG. 21 is a conceptual diagram of searching processing of a cross point.

### DESCRIPTION OF THE PREFERRED EMBODIMENTS

Referring to the drawings, embodiments of the present invention are described in detail. The same or corresponding portions in the figures are denoted by the same reference numerals, and their descriptions are not repeated.

As a representative example of an image processing apparatus according to the present invention, a multi function peripheral (hereinafter, also referred to as “MFP”) with a scanning function in addition to a color printing function (image formation function) such as a printing function and a copy function is described below.

<Overview>

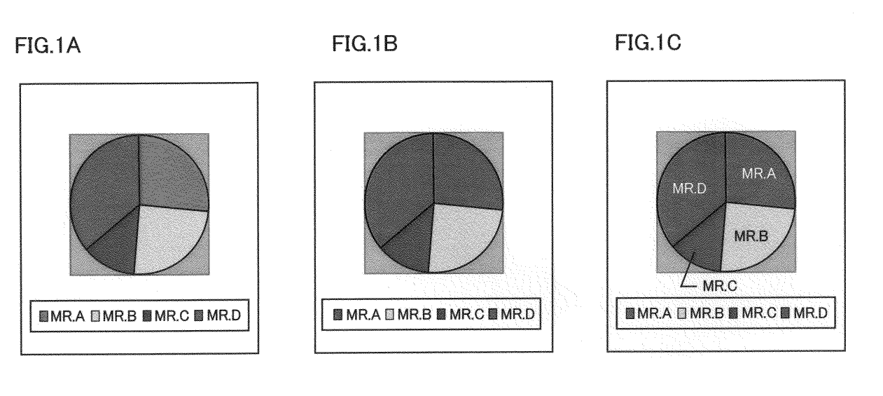

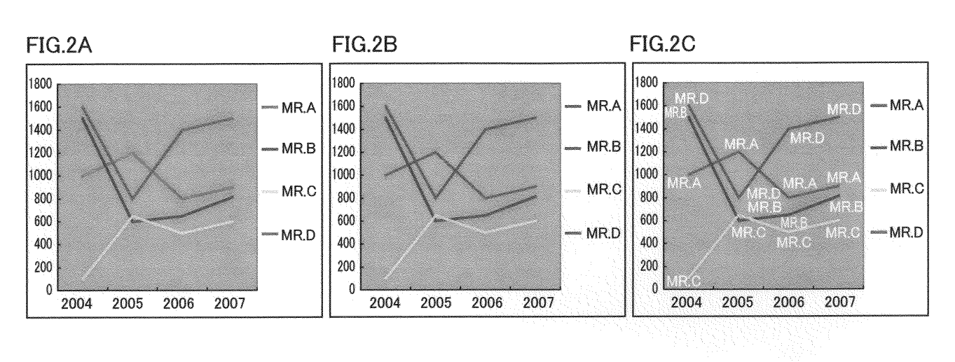

In image processing according to an embodiment of the present invention, information indicated by colors (representatively, contents of a legend) is added to an image including a color graph while maintaining original information. Referring to FIGS. 1A to 1C and FIGS. 2A to 2C, one example of the image processing according to the embodiment of the present invention is illustrated.

Referring to FIG. 1A, for example, a circular graph that is divided by four colors (red, blue, yellow, and green) is assumed. In this circular graph, corresponding colors indicate certain information (e.g., proportions of items corresponding to the respective colors to total) in accordance with planar dimensions of respective areas. Furthermore, the items corresponding to the respective colors are described separately from the circular graph as a legend.

For instance, since for people with protanopia/deuteranopia, “red” and “green” look the same, the graph shown in FIG. 1A looks like that in FIG. 1B for them. Namely, the people with protanopia/deuteranopia cannot discern the area of “red” and the area of “green”. At this time, since the people with protanopia/deuteranopia cannot identify “red” corresponding to “Mr. A” and “green” corresponding to “Mr. B” in the legend, either, they cannot sufficiently read the information described in the graph shown in FIG. 1A.

Consequently, in the image processing according to a first embodiment, information indicated by the colors is added to the graph as shown in FIG. 1A to generate an image as shown in FIG. 1C.

Moreover, referring to FIG. 2A, for example, a line graph including four colors (red, blue, yellow, and green) is assumed. In this line graph, the corresponding colors indicate certain information (e.g., change of items corresponding to the respective colors and the like) in accordance with positions of the lines in the respective colors. Furthermore, the items corresponding to the respective colors are described separately from the line graph as a legend.

As described above, since for the people with protanopia/deuteranopia, “red” and “green” look the same, the graph shown in FIG. 2A looks like that in FIG. 2B for them. The people with protanopia/deuteranopia, thus, cannot sufficiently read out the information described in the graph.

Consequently, in the image processing according to a second embodiment, character information or the like is added to the graph as shown in FIG. 2A at a start point, an end point, a cross point, and the like of the line in each of the colors to generate an image as shown in FIG. 2C.

In such manner, according to the image processing of the embodiments, there can be obtained an image that enables the smooth communication between people with normal color vision and people with impaired color vision to be realized by adding the information indicated by the colors while maintaining the original information.

### First Embodiment

<Apparatus Configuration>

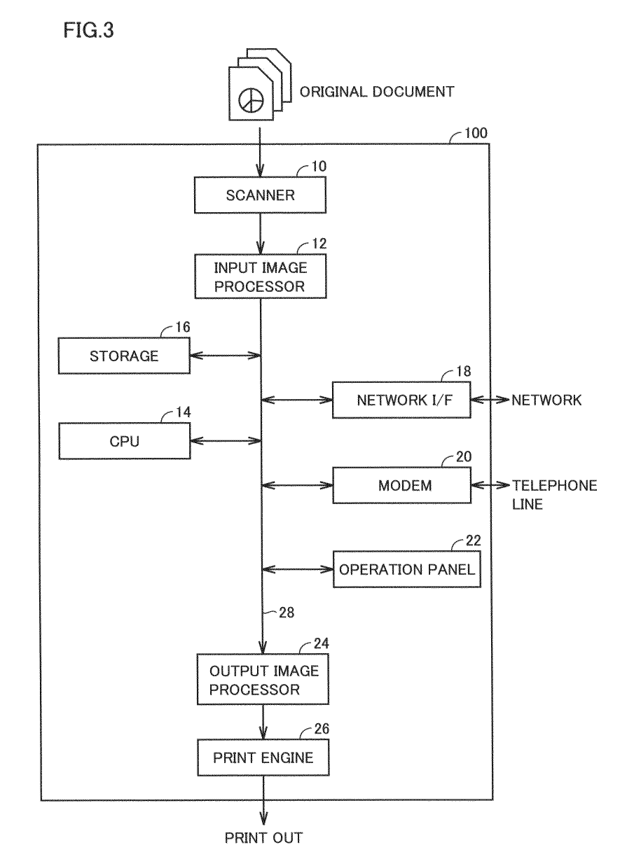

FIG. 3 is a block diagram showing an apparatus configuration of an MFP 100 according to the first embodiment of the present invention. Referring to FIG. 3, MFP 100 scans an original document in which a color graph and the like are described, applies the image processing according to the present embodiment as described above, and outputs (prints out or outputs the data of) the image (synthetic image data) as shown in FIG. 1C and/or FIG. 2C.

Specifically, MFP 100 includes a scanner 10, an input image processor 12, a CPU (Central Processing Unit) 14, a storage 16, a network I/F (Interface) 18, a modem 20, an operation panel 22, an output image processor 24, and a print engine 26, and these units are connected to one another through a bus 28.

Scanner 10 scans image information from an original document to generate input image data. This input image data is sent to input image processor 12. More specifically, scanner 10 irradiates the original document placed on a platen glass with light from a light source, and receives light reflected from the original document by image pickup elements arrayed in a main scanning direction, or the like to thereby obtain the image information on the original document. Alternatively, scanner 10 may include a document feeder tray, a delivery roller, a resist roller, a carrier drum, a paper discharge tray, and the like so as to enable successive original document scanning.

Input image processor 12 performs input image processing such as color conversion processing, color correction processing, resolution conversion processing, and area distinction processing to the input image data received from scanner 10. Input image processor 12 outputs data after the input image processing to storage 16.

CPU 14 is a processor in charge of overall processing of MFP 100, and representatively, various types of processing described later are provided by executing a program stored in advance. More specifically, CPU 14 performs detection of a key operated on operation panel 22, control over display on operation panel 22, conversion processing of an image format (JPEG (Joint Photographic Experts Group), PDF, TIFF (Tagged Image File Format) or the like) of the input image data, control over communication through a network and/or a telephone line, and the like.

Storage 16 stores the program codes executed by CPU 14, the input image data outputted from input image processor 12, and the like. Representatively, storage 16 includes a volatile memory such as DRAM (Dynamic Random Access Memory), and a nonvolatile memory such as a hard disk drive (HDD) and/or a flash memory. Moreover, storage 16 stores image data generated by the image processing according to the present embodiment.

Network I/F 18 performs data communication with a server apparatus (not shown) and the like through a network such as a LAN (Local Area Network).

Modem 20 is connected with the telephone line to transmit and receive FAX data with respect to another MFP and the like. Representatively, modem 20 includes an NCU (Network Control Unit).

Operation panel 22 is a user interface that presents a user with operation information such as an operation menu and a job execution status, and receives a user instruction in accordance with pressing by the user. More specifically, operation panel 22 includes a key input unit as an input unit, and a touch panel as an input unit configured integrally with a display. The key input unit includes ten keys and keys to which respective functions are assigned, and outputs commands corresponding to the key pressed by the user to CPU 14. The touch panel is made up of a liquid crystal panel and a touch operation detector provided on the liquid crystal panel, visually displays various types of information to the user, and upon detecting a touch operation by the user, outputs commands corresponding to the touch operation to CPU 14.

Output image processor 24 performs output image processing such as screen control, smoothing processing, and PWM (Pulse Width Modulation) control to synthetic image data described later when the synthetic image data is to be printed out. Output image processor 24 outputs image data after the output image processing to print engine 26.

Print engine 26 prints (or forms) the image in color on paper based on the image data received from output image processor 24. Representatively, print engine 26 is made of an electrophotographic image formation unit. More specifically, print engine 26 includes an imaging unit of four colors of yellow (Y), magenta (M), cyan (C), and black (K), a transfer belt, a fixing device, a paper feeder, a paper discharger and the like. The imaging unit is made up of a photoreceptor drum, an exposure unit, a developing unit and the like.

The image processing according to the present embodiment may be applied to input image data received from another image processing apparatus or an information processing apparatus such as a personal computer in place of the input image data generated by scanner 10 scanning from the original document.

<Functional Configuration>

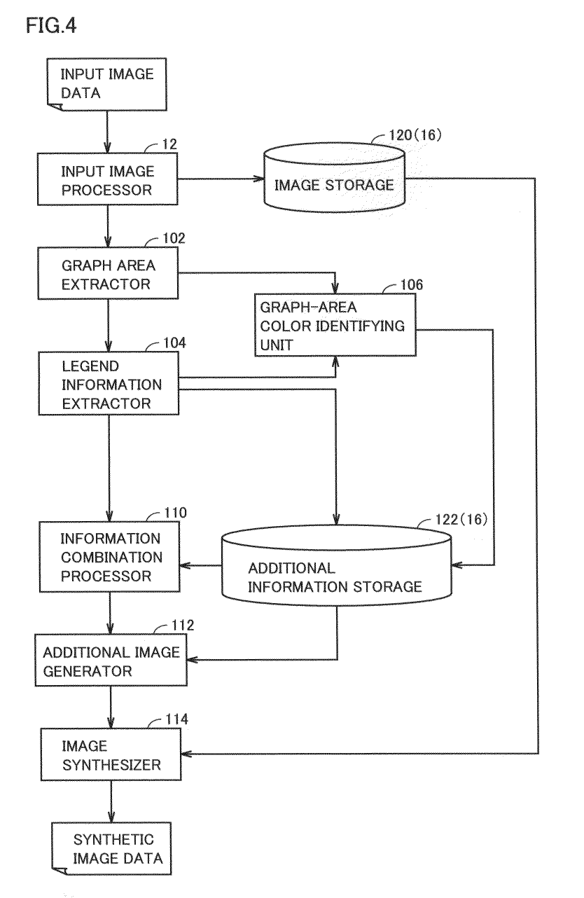

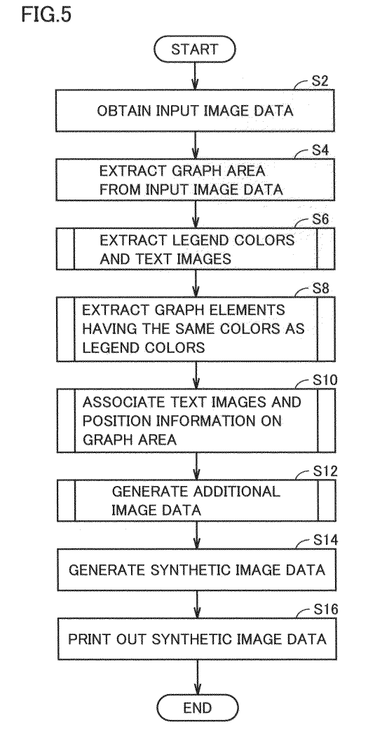

FIG. 4 is a block diagram showing a functional configuration relating to the image processing in MFP 100 according to the first embodiment of this invention.

Referring to FIG. 4, MFP 100 includes input image processor 12, a graph area extractor 102, a legend information extractor 104, a graph-area color identifying unit 106, an information combination processor 110, an additional image generator 112, an image synthesizer 114, an image storage 120, and an additional information storage 122 as functions thereof. Among these functions, graph area extractor 102, legend information extractor 104, graph-area color identifying unit 106, information combination processor 110, additional image generator 112 and image synthesizer 114 are provided by CPU 14 (FIG. 3). Moreover, image storage 120 and additional information storage 122 are provided by storage 16 (FIG. 3).

Referring to FIG. 4, input image processor 12 generates raster data from the input image data generated by scanner 10 (FIG. 3). Input image processor 12 outputs the generated raster data to graph area extractor 102, and also stores the same in image storage 120.

Graph area extractor 102 specifies a graph area included in the input image data (raster data), and extracts the specified graph area to output image data of the extracted graph area to graph-area color identifying unit 106.

Legend information extractor 104 extracts legend information from an area other than the graph area included in the input image data (raster data). More specifically, legend information extractor 104 specifies colors associated with respective items of the legend (hereinafter, each referred to as “legend color”), and text images representing the items of the legend associated with the respective legend colors. Legend information extractor 104 outputs the color information of the respective specified legend colors to graph-area color identifying unit 106, and stores the color information of the specified legend colors and the text images of the extracted items in additional information storage 122.

Graph-area color identifying unit 106 extracts areas (pixels) having the same colors as the respective legend colors specified in legend information extractor 104, and specifies position information (representatively, coordinate positions) indicating the extracted areas (graph elements). Graph-area color identifying unit 106 stores the specified position information of the respective areas to additional information storage 122.

Information combination processor 110 associates the respective text images with the position information on the graph area to add the text images to, based on the color information of the respective legend colors and the corresponding text images, and the position information of the areas having the same colors as the respective legend colors, which are stored in additional information storage 122. That is, information combination processor 110 determines in which position on the graph area each of the text images is to be added.

Additional image generator 112 generates an image to be added to the input image data, based on correspondence relationships generated in information combination processor 110. Namely, additional image generator 112 generates additional image data in which the respective text images extracted by legend information extractor 104 are arranged in the corresponding positions.

Image synthesizer 114 synthesizes the input image data generated by scanner 10 (FIG. 3) and the additional image data generated in additional image generator 112 to generate synthetic image data. This synthetic image data represents the above-described graph as shown in FIG. 1C or 2C.

<Overall Processing Procedure>

FIG. 5 is a flowchart showing an overall processing procedure of the image processing according to the first embodiment of this invention.

Referring to FIG. 5, first of all, input image data is obtained (step S2). Specifically, scanner 10 (FIG. 3) scans image information from an original document to generate the input image data. Alternatively, MFP 100 receives input image data from another image processing apparatus or an information processing apparatus such as a personal computer.

Subsequently, a graph area is extracted from the input image data (step S4). Legend colors and text images are extracted from a legend area included in the input image data (step S6). Furthermore, areas (graph elements) having the same colors as the respective legend colors are extracted from the graph area (step S8).

Thereafter, the text images of the legend and position information on the graph area are associated (step S10). Additional image data is generated from the text images extracted in step S6, based on the correspondence relationships generated in step S10 (step S12).

Finally, synthesizing the additional image data generated in step S12 with the original input image data allows synthetic image data to be generated (step S14). Furthermore, if necessary, the generated synthetic image data is printed out (step S16). Alternatively, in place of the printing-out, the synthetic image data may be transmitted to another image processing apparatus or an information processing apparatus such as a personal computer.

Hereinafter, a detailed description of main processing is given.

<(1) Extraction of Graph Area Included in Input Image Data (Step S4)>

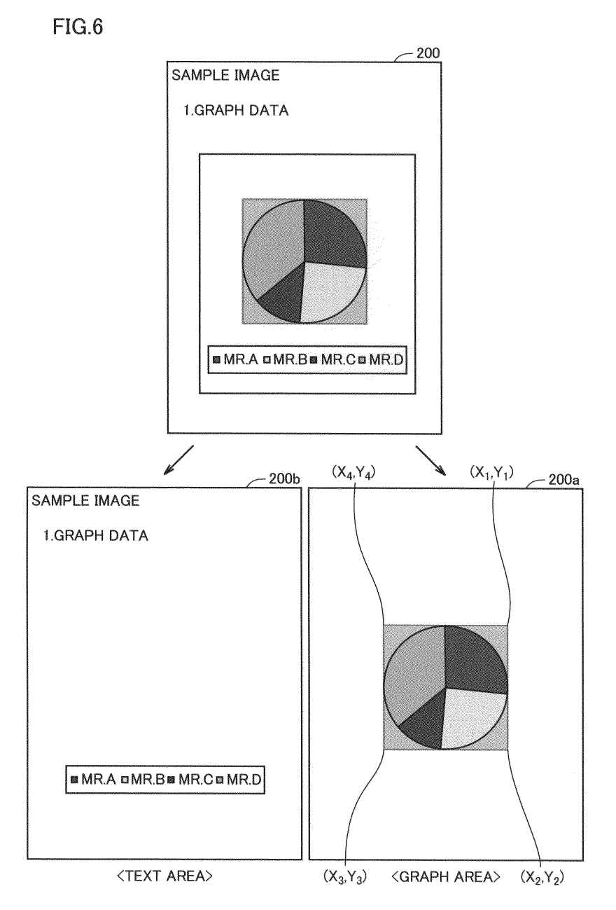

FIG. 6 is a conceptual diagram of the processing relating to step S4 in FIG. 5.

Referring to FIG. 6, in step S4 of FIG. 5 (in graph area extractor 102 in FIG. 4), the graph area included in input image data 200 and an area other than this (text area) are separated. Namely, a graph area 200a corresponding to the graph area, and image data 200b corresponding to the text area are extracted from input image data 200. Furthermore, for extracted graph area 200a, position information indicating a range thereof (X₁, Y₁) to (X₄, Y₄) is specified.

Generally, the graph area is an aggregate of relatively high-density portions, and thus, the section of high-density aggregation in the input image data is determined to be the graph area.

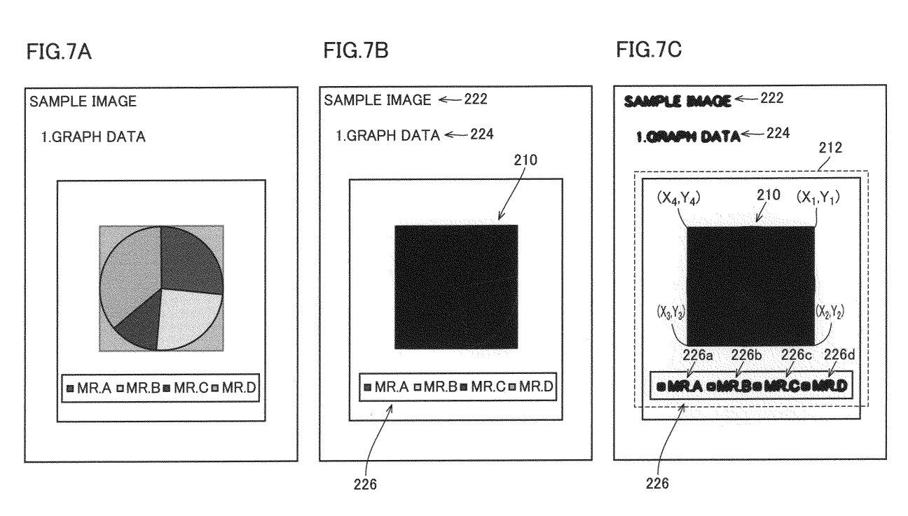

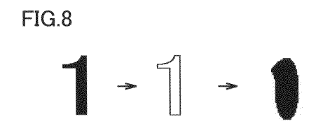

FIGS. 7A to 7C are diagrams for illustrating more detailed processing for extracting the graph area shown in FIG. 6. Binarization processing is executed to the input image data as shown in FIG. 7A. That is, the density of respective pixels is compared with a predetermined threshold to thereby distinguish pixels whose density is larger than the threshold from pixels whose density is smaller than the threshold. The above-described binarization processing allows the input image data as shown in FIG. 7A to be converted to that as shown in FIG. 7B. As a result, in the image data obtained by the binarization processing as shown in FIG. 7B, a section 210 of a high-density aggregation is extracted as the graph area. At the same time, position information indicating a range of the extracted graph area is specified.

Moreover, since a character has a property that an outline thereof is clear, the image data obtained by the binarization processing is subjected to edge detection processing to extract text areas. As a result, in the image data shown in FIG. 7B, areas 222, 224, 226 are extracted as the text areas.

Expansion processing is executed to the extracted text areas as preprocessing of extraction of a legend area described later. Namely, a preset number of pixels are added to pixels detected as edges to thereby expand the characters, and a state of the expanded characters is stored in storages 16 (FIG. 3). One example of a result from subjecting the expansion processing to the image data shown in FIG. 7B is shown in FIG. 7C.

FIG. 8 is a diagram for illustrating more detailed contents of the expansion processing.

Referring to FIG. 8, by executing the edge detection processing to each of the characters, a void shape representing an outline of the character is obtained. The addition of the preset number of pixels to this void shape can expand the original character.

<(2) Extraction of Legend Colors and Text Images from Legend Area (Step S6)>

Generally, since the legend is arranged close to the graph, the text area close to the graph area is extracted as a legend area in input image data 200. The legend colors and corresponding text images included in this legend area are obtained as legend information. More specifically, the text area existing within a predetermined range from the graph area is searched, and the searched text area is treated as the legend area.

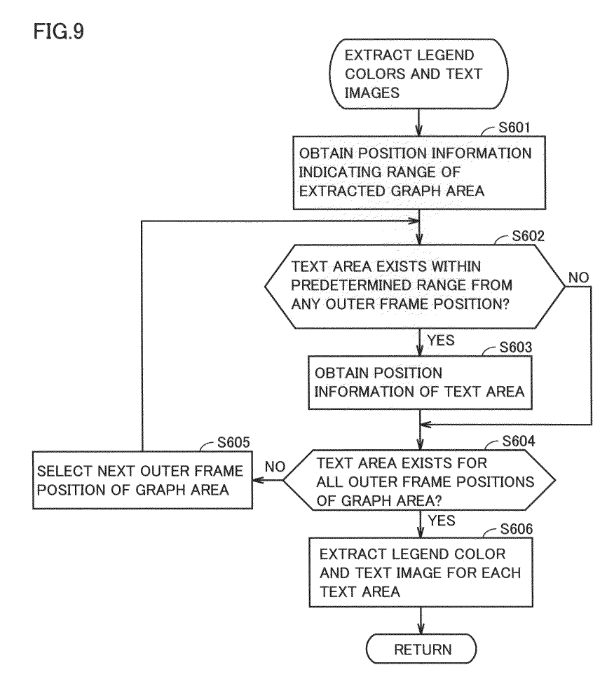

FIG. 9 is a flowchart showing a more detailed processing procedure relating to step S6 of the flowchart shown in FIG. 5.

Referring to FIG. 9, first of all, the position information (X₁, Y₁) to (X₄, Y₄) indicating the range of the graph area extracted in step S4 in FIG. 5 is obtained (step S601). Subsequently, it is determined whether or not any text area exists within the predetermined range from any outer frame position in the graph area based on the position information of the graph area (step S602). While this predetermined range can be set depending on the situation, for example, when a scanning accuracy of scanner 10 is 300 dpi, it may be set to a range of vertical and horizontal 1000×200 pixels.

If it is determined that some text area exists within the predetermined range from the certain outer frame position (in the case of YES in step S602), then the position information of the text area is obtained (step S603).

If it is determined that no text area exists within the predetermined range from the certain outer frame position (in the case of NO in step S602), or after the position information of the text area has been obtained (after the execution of step S603), it is determined whether or not the determination as to whether or not any text area exists for all the outer frame positions of the graph area has been completed (step S604). If it is determined that the determination as to whether or not any text area exists has not been completed (in the case of NO in step S604), then the next outer frame position of the graph area is selected (step S605), and the processing of the step S602 and later is repeated.

If it is determined that the determination as to whether or not any text area exists has been completed (in the case of YES in step S604), a legend color and a text image are extracted for each of the text areas based on the position information obtained in step S603 (step S606). More specifically, a graphic portion included in each of the text areas (i.e., an area that has a predetermined planar dimension and is daubed) is extracted, and color information (representatively, RGB value) of the graphic portion is obtained and a portion excluding the graphic portion from each of the text areas is extracted as the text image. A plurality of pixels are included in each of the graphic portions, and the color information having these pixels is not necessarily the same. Therefore, a representative value (e.g., an average value or mode value) of the color information that the pixels making up each of the graphic portions have is stored. The processing then returns.

As shown in FIG. 7C, it is determined whether or not any text area exists within a searching range 212 at a predetermined distance from the outer frame of graph area 210. In the example shown in FIG. 7C, four text areas 226a to 226d are extracted, and the legend color and the text image are extracted for each of these text areas 226a to 226d.

<(3) Extraction of Graph Element Having Same Color as Each Legend Color from Graph Area (Step S8)>

By the above-described processing, when the legend color associated with each of the items of the legend has been extracted, the graph element having the same color as each of the legend colors is extracted pixel by pixel.

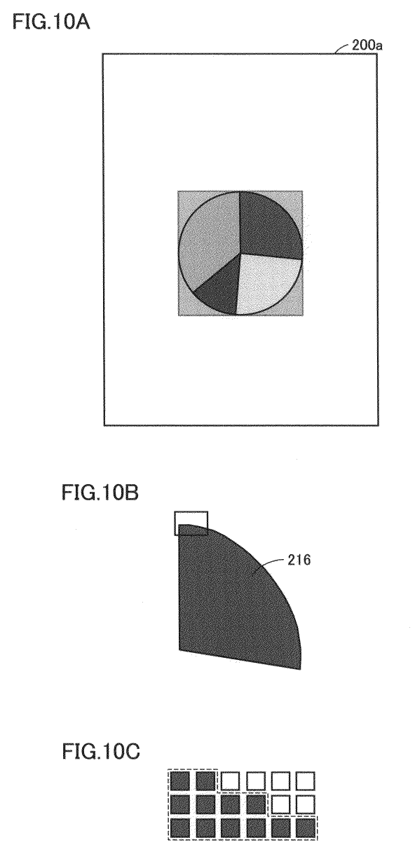

Among the pixels making up graph area 200a as shown in FIG. 10A, pixels having the same color as each of the legend colors extracted from the legend area are extracted. For example, as shown in FIG. 10C, identifying the pixels having the same color as the legend color allows a graph element 216 included in graph area 200a to be extracted (FIG. 10B).

FIG. 11 is a flowchart showing a more detailed processing procedure relating to step S8 of the flowchart shown in FIG. 5.

Referring to FIG. 11, first of all, the color information (representatively, RGB value) of each of the extracted legend colors in step S6 in FIG. 5 is obtained (step S801). Subsequently, it is determined whether or not a subject pixel included in the graph area has the same color information as the subject legend color (step S802). If the subject pixel has the same color information as the subject legend color (in the case of YES in step S802), then the position information of the subject pixel is obtained (step S803).

If the subject pixel does not have the same color information as the subject legend color (in the case of NO in step S802), or after the position information of the subject pixel has been obtained (after execution of step S803), it is determined whether or not the determination for all the pixels included in the graph area has been completed (step S804). If it is determined that the determination for all the pixels included in the graph area has not been completed (in the case of NO in step S804), the next pixel included in the graph area is selected as the subject pixel (step S805), the processing in step S802 and later is repeated.

If it is determined that the determination for all the pixels included in the graph area has been completed (in the case of YES in step S804), then it is determined whether or not the determination for all the extracted legend colors has been completed (step S806). If it is determined that the determination for all the legend colors has not been completed (in the case of NO in step S806), the next legend color is selected as the subject legend color (step S807), and the processing in step S802 and later is repeated.

If it is determined that the determination for all the legend colors has been completed (in the case of YES in step S806), then the processing returns.

<(4) Configuration of Correspondence Relationships Between Text Image and Position Information on Graph Area (Step S19)>

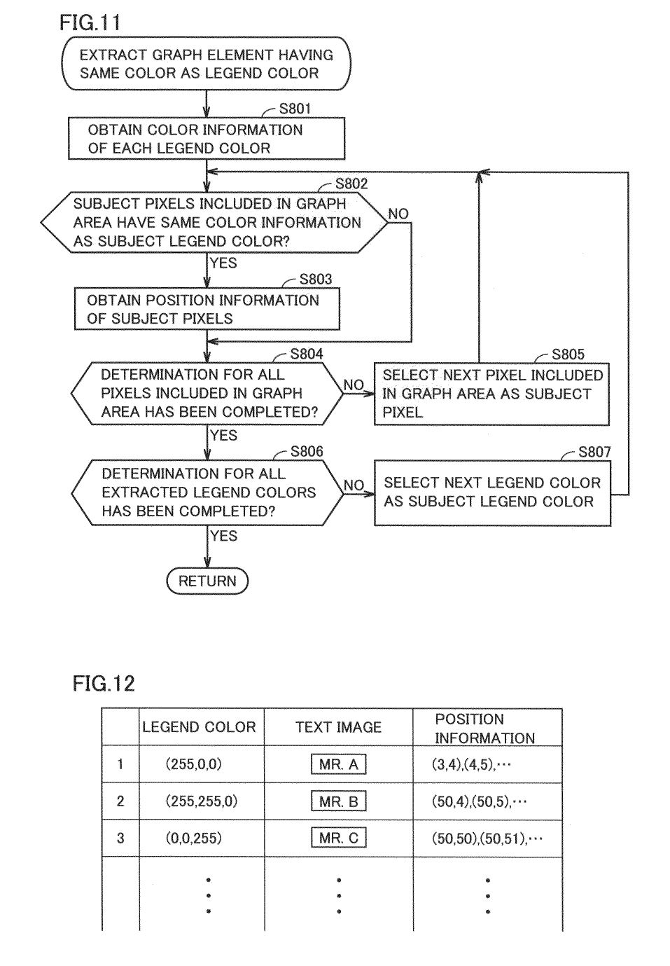

FIG. 12 is a structural diagram showing one example of correspondence relationships generated by the processing in step S10 of the flowchart shown in FIG. 5.

Referring to FIG. 12, the correspondence relationships are defined, in which the text images indicating the respective items of the legend and the position information of the graph elements having the same colors as the respective legend colors are described in association with the respective extracted legend colors. Here, the position information of the graph elements may indicate at least outer edges of the respective graph elements, and does not need to include position information of all the pixels making up the respective graph elements. As an actual data structure, the table as shown in FIG. 12 does not need to be generated, but any data structure that defines the mutual correspondence relationships may be employed.

<(5) Generation of Additional Image Data (Step S12)>

Next, additional image data to be added to the input image data is generated based on the correspondence relationships as shown in FIG. 12. In the generation processing of this additional image, whether or not the corresponding items of the legend can be added within the respective graph elements is determined. The item that cannot be added within the graph element is added outside the graph element. On the other hand, the item that can be added within the graph element is added in an appropriate color within the graph element. A detailed description of the processing is now given.

(i) Determination Processing as to Whether or Not the Item can be Added Within the Graph Element

First, for each of the graph elements, it is determined whether or not any character has been described in advance.

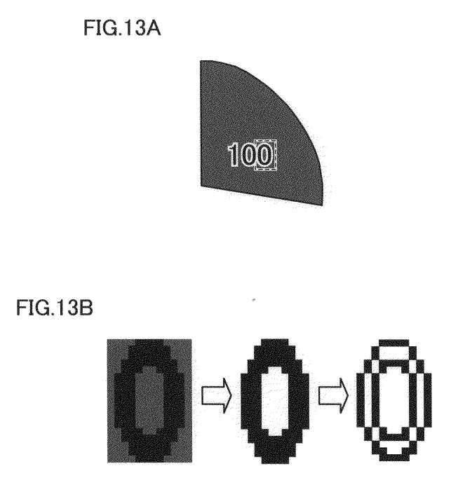

FIGS. 13A and 13B are conceptual diagrams of processing for determining whether or not any character has been described in each of the graph elements in advance. As shown in FIG. 13A, a case where characters (e.g., “100” indicating a value of the graph element) are described is assumed.

In order to determine whether or not any character has been described in this graph element in advance, the edge detection processing is performed to each of the graph elements. Specifically, as shown in FIG. 13B, pixels having the same color information as the corresponding legend color are removed from the pixels making up the graph element, the remaining pixels are subjected to the edge detection processing. By performing the above-described edge detection processing, when a character such as “0” exists in the graph element, a void shape representing an outline of that character is obtained.

On the other hand, if no character exists in the graph element, that is, if almost all the pixels making up the graph element have the same color information as the corresponding legend color, then such a shape representing the outline of the character is not obtained.

By the above-described processing, whether or not any character is described within each of the graph elements is determined. If any character is described within the graph element, the text image corresponding to the graph element is added outside the graph element as will be described later.

Next, in the case where no character is described in the graph element, whether or not a size (or a ratio of a planar dimension) of the graph element area is larger than a predetermined threshold is determined. If the size of the graph element area is not larger than the predetermined threshold, the text image corresponding to the graph element is added outside the graph element as will be described later. On the other hand, if the size of the graph element area is larger than the predetermined threshold, a size of the text image to be added and the size of the graph element area are compared to determine whether or not the text image can be added within the graph element.

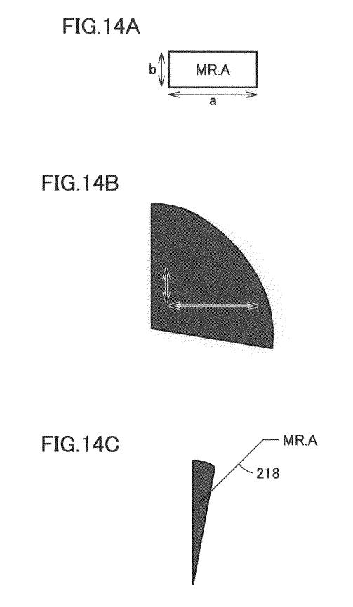

FIGS. 14A to 14C are conceptual diagrams of processing for comparing the size of the text image to be added and the size of the graph element area.

First, as shown in FIG. 14A, the size (e.g., a pixels×b pixels) of the area of the text image to be added to each of the graph elements is extracted. Whether or not the text image can be arranged within the subject graph element, that is, whether or not the subject graph element area is large enough for the size of the text image area is determined. As shown in FIG. 14B, if the subject graph element area is large enough for the text image to be added, the text image is added within the graph element. On the other hand, as shown in FIG. 14C, if the subject graph element area is too small for the text image to be added, the text image is added outside the graph element.

(ii) Processing in the Case Where the Item is Added Outside the Graph Element

As described above, if any character is described within the graph element, or if the subject graph element area is too small for the text image to be added, a blank area close to the graph area is searched. The corresponding text image is arranged in the blank area obtained by searching, and a lead line 218 (refer to FIG. 14C) connecting between the graph element and the arranged text image is added.

(iii) Processing in the Case Where the Item is Added Within the Graph Element

As described above, if the subject graph element area is large enough for the text image to be added, the corresponding text image is added within the graph element. At this time, the color of the text image to be added is changed (inverted) as needed.

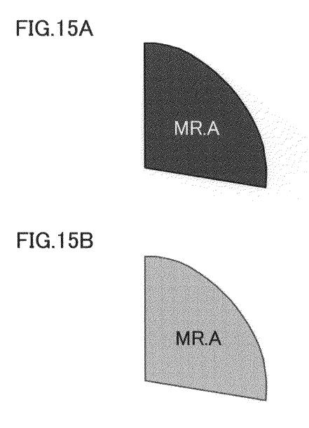

FIGS. 15A to 15C are conceptual diagrams of processing for deciding the color of the text image to be added. In this processing, if as shown in FIG. 15A, the density of the graph element is relatively high, it is determined that a “white” text image is to be added, while if as shown in FIG. 15B, the density of the graph element is relatively low, it is determined that a “black” text image is to be added. That is, based on the color information of each of the graph elements, which of a “white” character and a “black” character is to be used is determined.

Based on this determination result and the color information of the extracted text image, the text image to be added within the graph element is subjected to color conversion (negative/positive inversion) as needed.

(iv) Generation of Additional Image

As described above, since the position and the color of the text image to be added, the necessary lead line, and the like are set for each of the graph elements, an additional image is generated based on these pieces of information. In the present embodiment, adding the additional image to the input image data generated by the scanner 10 (FIG. 3) generates synthetic image data, and thus, any additional image that includes the text image and the lead line may be employed.

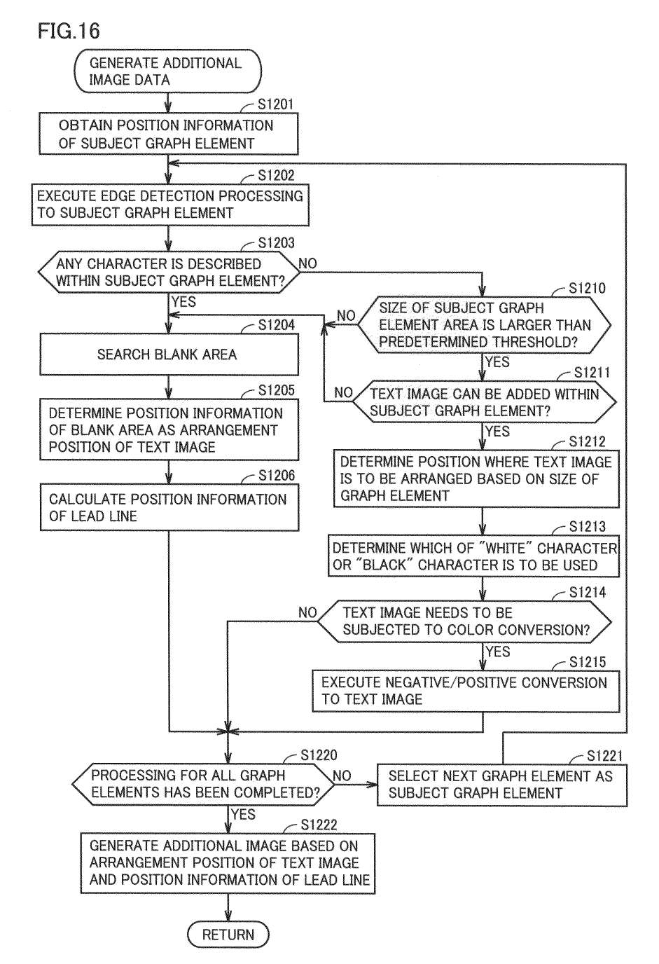

The processing procedures of the above-described (i) to (iv) are summarized in a flowchart shown in FIG. 16.

FIG. 16 is a flowchart showing a more detailed processing procedure relating to step S12 of the flowchart shown in FIG. 5.

Referring to FIG. 16, the correspondence relationships generated in step S10 in FIG. 5 is first referred to, and the position information of the subject graph element is obtained (step S1201). Subsequently, the edge detection processing is executed to the subject graph element (step S1202). Furthermore, based on a result of this edge detection processing, whether or not any character is described within the subject graph element is determined (step S1203). If any character is described within the subject graph element (in the case of YES in step S1203), the processing goes to step S1204, while if no character is described within the subject graph element (in the case of NO in step S1203), the processing goes to step S1210.

In step S1204, based on color information of pixels in the vicinity of the graph area, a blank area is searched. Position information of the blank area obtained by searching is determined as an arrangement position of the text image corresponding to the subject graph element (step S1205), and further position information of the lead line connecting the subject graph element and the arrangement position of the text image is calculated (step S1206). The processing goes to step S1220.

In step S1210, whether or not the size of the subject graph element area is larger than the predetermined threshold is determined. If the size of the subject graph element area is not larger than the predetermined threshold (in the case of NO in step S1210), the processing goes to step S1204.

If the size of the subject graph element area is larger than the predetermined threshold (in the case of YES in step S1210), the size of the text image to be added and the size of the subject graph element area are compared to determine whether or not the text image can be added within the subject graph element (step S1211). If the text image cannot be added within the subject graph element (in the case of NO in step S1211), the processing goes to step S1204.

If the text image can be added within the subject graph element (in the case of YES in step S1211), a position where the text image is to be arranged is determined based on the size of the graph element (step S1212).

Furthermore, based on the color information of the subject graph element, which of the “white” character and the “black” character is to be used as the item of the legend is determined (step S1213). Further, based on a determination result in step S1213 and the color information of the text image to be added, whether or not the text image needs to be subjected to the color conversion is determined (step S1214). If the text image does not need to be subjected to the color conversion (in the case of NO in step S1214), the processing goes to step S1220.

If the text image needs to be subjected to the color conversion (in the case of YES in step S1214), the negative/positive conversion is executed to the text image (step S1215). The processing then goes to step S1220.

In step S1220, whether or not the processing for all the graph elements included in the graph area has been completed is determined. If it is determined that the processing for all the graph elements has not been completed (in the case of NO in step S1220), the next graph element is selected as the subject graph element (step S1221) and the processing in step S1202 and later is repeated.

On the other hand, if it is determined that the processing for all the graph elements has been completed (in the case of YES in step S1220), the additional image is generated based on the arrangement position of the text image determined in step S1204 and S1212, and the position information of the lead line calculated in step S1205 (S1222). The processing then returns.

<Merits by the Present Embodiment>

According to the present embodiment, by adding the information indicated by the colors (information of the colors themselves and legend information) to the graph divided by color while maintaining the original colors, the output image data is generated. This allows smooth communication between people with normal color vision and people with impaired color vision to be realized.

### First Modification of First Embodiment

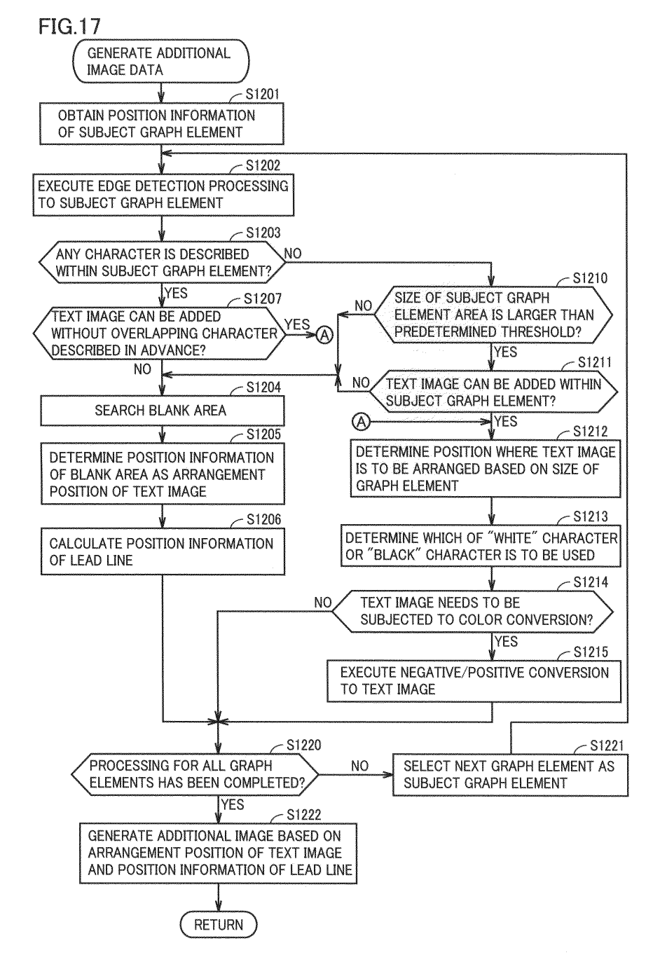

In the above-described first embodiment, the configuration is exemplified, in which if any character has been described within the graph element included in the graph area, the text image indicating the item of the legend is arranged outside the corresponding graph element. However, if the graph element has a large enough area, the text image may be arranged within the graph element even if any character has been described. In this case, in place of the flowchart shown in FIG. 16, a processing procedure described in a flowchart shown in FIG. 17 may be executed.

FIG. 17 is the flowchart showing a detailed processing procedure (first modification) relating to step S12 of the flowchart shown in FIG. 5. The flowchart shown in FIG. 17 results from adding processing in step S1207 to the flowchart shown in FIG. 16, and thus, different points are mainly described.

Referring to FIG. 17, in step S1203, if any character is described within the subject graph element (in the case of YES in step S1203), the processing goes to step S1207.

In step S1207, the area excluding the character obtained by the edge detection processing in the subject graph element and the size of the text image to be added are compared to determine whether or not the text image can be added without overlapping the character described within the subject graph element tentatively. If the text image cannot be added without overlapping the character described (in the case of NO in step S1207), the processing goes to step S1204.

On the other hand, if the text image can be added without overlapping the character described (in the case of YES in step S1207), the processing goes to step S1212.

The other processing is similar to the processing of the steps given the same reference numerals in FIG. 16, and thus, detailed descriptions are not repeated.

According to the present modification, since the text image is arranged within the graph element as much as possible, more information can be added to one piece of image data.

### Second Modification of First Embodiment

While in the above-described first embodiment, the configuration is exemplified, in which the area having the same color information as the legend colors (color information) obtained as the legend information is extracted as the graph area, the graph elements included in the graph area may be extracted independently of the legend information. This is because there is a possibility that not all the graph elements included in the graph area are described as the legend.

Here, in the case where the legend information is not used, since what colors are used as graph elements cannot be determined in advance, as one example, by grouping the color information of the respective pixels included in the graph area, the color information of the respective graph elements is extracted.

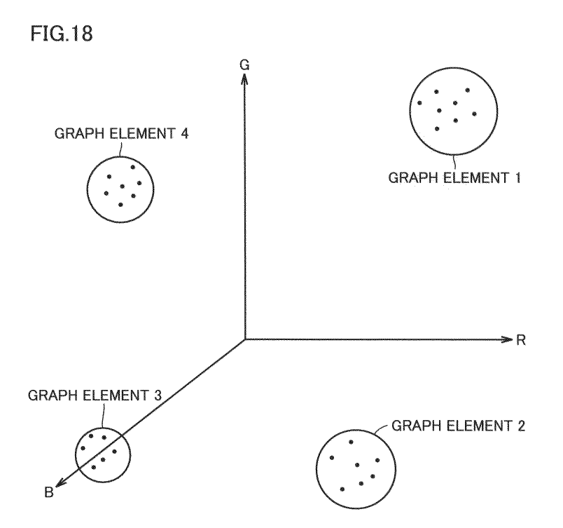

FIG. 18 is a conceptual diagram of processing for extracting the graph elements included in the graph area.

Referring to FIG. 18, when the color information (RGB information) of the respective pixels included in the graph area is plotted in a three-dimensional color space of RGB, the pixels making up the graph area appear as aggregates. Using a publicly known grouping method, these pixels are classified into several groups to obtain a representative value of each of the groups as color information of each of the graph elements. According to the above-described method, a number of the classified groups corresponds to a number of the graph elements included in the graph area. Furthermore, by comparing the obtained color information of each of the groups and the legend color to associate the analogous ones with each other, relationships between each of the graph elements and the legend information can be constructed. Furthermore, for the graph element whose legend information does not exist, only a text image indicating a color such as “red” or “blue” may be added based on the corresponding color information.

According to the present modification, even when the legend information and each of the graph elements are not in one-to-one correspondence, the information indicating the respective graph elements can be grasped in more detail.

### Third Modification of First Embodiment

While in the above-described first embodiment, the configuration is exemplified, in which the text image extracted as the legend information is added to the corresponding graph element as it is, the extracted text image may be converted into text data and be added to the graph element.

That is, by executing character recognition processing to the extracted text image, text data indicating the item of the legend may be obtained to regenerate the text image based on this text data. The execution of the above-described processing allows the same information to be added within the graph element by appropriately setting a font size, a font type and the like even if the extracted text image cannot be added within the graph element as it is.

According to the present modification, the information indicated by the colors can be added to the graph element more freely.

### Fourth Modification of First Embodiment

While in the above-described first embodiment, the configuration is exemplified, in which only the text image extracted as the legend information is added to the graph element, information indicating the legend color of the corresponding graph element may be added in addition to the text image.

Namely, text data such as a character indicating each of the legend colors, for example, “red” or “blue” may be determined based on the color information (RGB information) of the each of the legend colors in the correspondence relationships shown in FIG. 12, and this text data may be added to each of the graph elements together with the corresponding text image.

According to the present modification, the people with impaired color vision can grasp the information indicated by the respective graph elements in more detail.

### Fifth Modification of First Embodiment

While in the above-described first embodiment, the configuration is exemplified, in which the information indicated by the colors is added to all the graph elements extracted as the legend colors, with a color that people with impaired color vision cannot identify, that is, a color that looks different between people with normal color vision and people with impaired color vision, the information indicated by the color may be added.

In this case, for example, an element for accepting selection by people with protanopia/deuteranopia or tritanopia (e.g. a button displayed on a screen or the like) is provided, and in accordance with this selection, the color whose information is to be added may be determined. As a method for determining this color whose information is to be added, color palettes in accordance with the respective types of people with the impaired color vision have been stored in advance, and the color whose information is to be added is specified by referring to these color palettes.

According to the present modification, a change range to the original document can be limited to a range in which appropriate communication between the people with normal color vision and the people with impaired color vision can be realized.

### Second Embodiment

While in the above-described first embodiment, the configuration is exemplified, in which the legend information is added to a color image mainly including a circular graph, the legend information can be added to a line graph.

The apparatus configuration and the functional configuration of MFP 100 according to the second embodiment of the present invention are similar to the above-described FIGS. 3 and 4, respectively, and detailed descriptions are thus not repeated. Moreover, an overall processing procedure of image processing according to the second embodiment is also similar to that in FIG. 5, and detailed descriptions are thus not repeated, either.

The image processing according to the second embodiment is basically the same to the image processing according to the above-described first embodiment except that the processing contents of step S12 in FIG. 5 are different, and detailed descriptions of the same processing are thus not repeated. Hereinafter, processing contents different from the image processing according to the first embodiment are described.

<Generation of Additional Image Data (Step S12)>

As shown in the above-described FIG. 2C, according to the image processing of the present embodiment, to the line in each of the colors (graph element) included in the line graph is added the information (legend information) indicated by the color at at least one of a start point and an end point, and a direction indicating point at a predetermined distance from a cross point with another line (another graph element). If the legend information is added at the cross point as it is, it is hard to understand which of the plurality of crossing lines the information denotes, and thus, the legend information is added at the direction indicating point at the predetermined distance from the cross point.

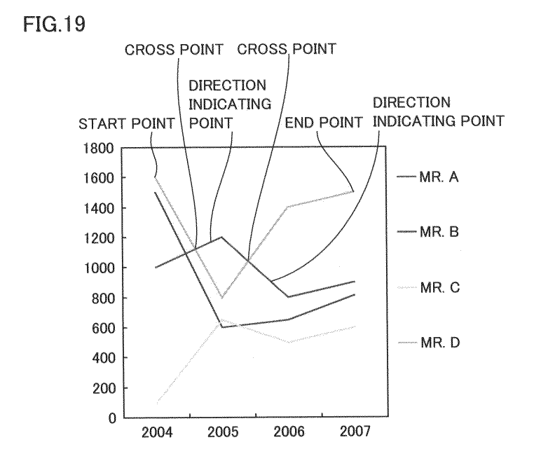

FIG. 19 is a conceptual diagram of searching processing to the graph area including the line graph.

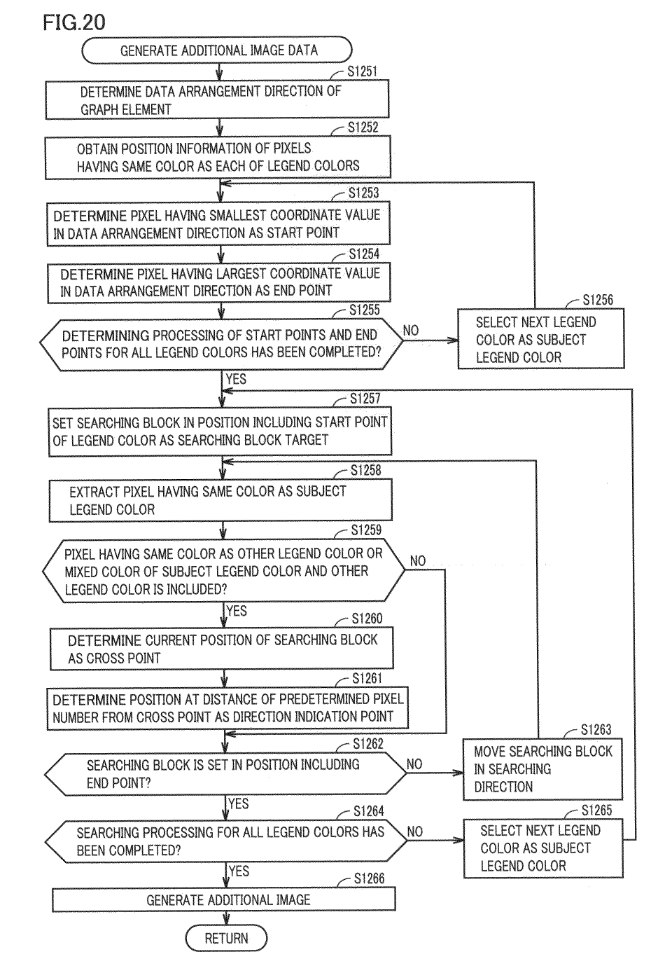

Referring to FIG. 19, in generation processing of the additional image data according to the present embodiment, for the line in each of the colors as the graph element, a start point and an end point, and a cross point and a direction indicating point are searched. While FIG. 19 illustrates the start point and the end point, and the cross point and the direction indicating point, which have been searched for one line, similar searching is executed to all the lines included in the line graph. Referring to FIG. 20, a processing procedure relating to the above-described searching processing is described.

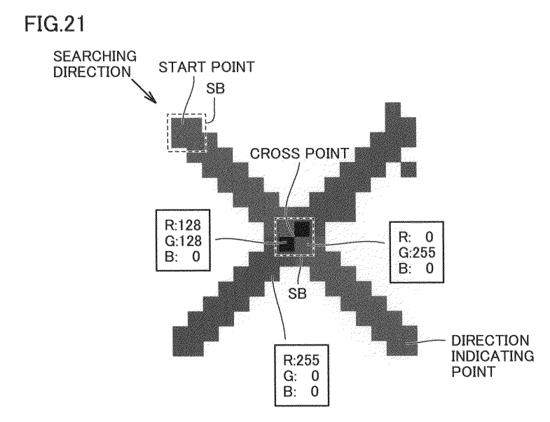

FIG. 20 is a flowchart showing a more detailed processing procedure (the second embodiment) relating to step S12 of the flowchart shown in FIG. 5. Further, FIG. 21 shows a conceptual diagram of searching processing of a cross point

Referring to FIG. 20, a data arrangement direction of the graph element is first determined (step S125). Specifically, it is determined along which axial direction (X direction or Y direction) the data is arranged, based on an orientation of the character included in the graph element and/or an arrangement position of a scale.

Subsequently, position information (coordinate positions) of pixels having the same color as each of the legend colors extracted in step S8 is obtained (step S1252). Subsequently, for the subject legend color, the position information having a smallest coordinate value in the data arrangement direction in the position information of the pixels having the same color as the legend color is determined as the position information of the start point (step S1253), and further the position information having a largest coordinate value in the data arrangement direction is determined as the position information of the end point (step S1254).

That is, for example, if it is determined that the data is arranged in the X direction, the pixels having the smallest coordinate value and the largest coordinate value in the X direction of the pixels having the same color as the subject legend color are selected as the start point and the end point, respectively.

It is then determined whether or not the determining processing of the start points and the end points has been completed for all the legend colors (step S1255). If it is determined that the determining processing for all the legend colors has not completed (in the case of NO in step S1255), the next legend color is selected as the subject legend color (step S1256), and the processing in step S1253 and later is repeated.

On the other hand, if it is determined that the determining processing for all the legend colors has been completed (in the case of YES in step S1255), the searching processing of the cross point in step S1257 and later is executed.

In step S1257, a searching block (e.g., 2 pixels×2 pixels) is set in a position including the start point for the subject legend color, which has been determined in step S1253 (or the end point for the subject legend color, which is determined in step S1254). That is, as shown in FIG. 21, a searching block SB is set in the position including the start point.

The pixel having the same color as the subject legend color is extracted from the pixels included in relevant searching block SB (step S1258). Furthermore, it is determined whether or not the pixel having the same color as the other legend color or the pixel having the same color as a mixed color of the subject legend color and the other legend color is included in relevant searching block SB (step S1259). If the pixel having the same color as the other legend color or the pixel having the same color as the mixed color of the subject legend color and the other legend color is not included in relevant searching block SB (in the case of NO in step S1259), the processing goes to step S1262.

If the pixel having the same color as the other legend color or the pixel having the same color as the mixed color of the subject legend color and the other legend color is included in relevant searching block SB (in the case of YES in step S1259), the current position of the relevant searching block is decided as the cross point (step S1260). Furthermore, a position at a distance of a predetermined pixel number (e.g., 10 pixels) from this cross point is decided as the direction indicating point (step S1261). The processing then goes to step S1262.

As a specific example, as shown in FIG. 21, during searching a line described in green (R:0 G:255, B:0), when an intersection with a line described in red (R:255, G:0, B:0) is reached, the pixel having a mixed color of green and red (R:128, G:128, B:0) is included in searching block SB. In such a case, the current position of the searching block is determined to be the cross point.

In step S1262, it is determined whether or not the searching block is set in a position including the end point (or the start point for the subject legend color determined in step S1253). If the searching block is not set in the position including the end point (in the case of NO in step S1262), the searching block moves in the searching direction so as to include a pixel having the same color as the subject legend color included in the searching block (step S1263), and the processing in step S1258 and later is executed again.

On the other hand, if the searching block is set in the position including the end point (in the case of YES in step S1262), it is determined whether or not the searching processing for all the legend colors has been completed (step S1264). If the searching processing for all the legend colors has not been completed (in the case of NO in step S1264), the next legend color is selected as the subject legend color (step S1265), and the processing in step S1257 and later is repeated.

On the other hand, if it is determined that the searching processing for all the legend colors has been completed (in the case of YES in step S1264), the additional image is generated based on the respective types of position information (of the start point decided in step S1253, the end point determined in step S1254, and the direction indicating point decided in step S1261), (step S1266). The processing then returns.

<Merits by Present Embodiment>

According to this present embodiment, by adding the information indicated by the colors (information of the colors themselves and the legend information) to the graph divided by color while maintaining the original colors, the output image data can be generated. This allows smooth communication between people with normal color vision and people with impaired color vision to be realized.

<Modifications of Second Embodiment>

The above-described second to fifth modifications of the first embodiment may be similarly applied to the second embodiment.

### Other Embodiments

While in the above-described embodiment, as a representative example of the image processing apparatus according to the present invention, MFP 100 has been illustrated, the image processing apparatus according to the present invention may be implemented by a personal computer connected to a scanner. In this case, installing an image processing program according to the present invention in the personal computer allows the personal computer to serve as the image processing apparatus according to the present invention.

Furthermore, the image processing program according to the present invention may also load necessary modules in a predetermined sequence and at predetermined timing among program modules provided as a part of the operating system so as to execute the processing related to the loaded modules. In this case, the above-described modules may not be included in the program itself, but the processing may be executed in cooperation with the operating system. The program not including the above-described modules can also be included by the program according to the present invention.

The image processing program according to the present invention may also be provided by being incorporated in a part of another program. Also, in this case, the modules included in the above-described another program are not included in the program itself, but the processing is executed in cooperation with the other program. The above-described program incorporated in the other program can also be included by the program according to the present invention.

A provided program product is installed in a program storage such as a hard disk to be executed. The program product includes the program itself, and a storage medium in which the program is stored.

Furthermore, some or all of the functions implemented by the image processing program according to the present invention may be configured by dedicated hardware.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing apparatus, comprising:
a first extractor for extracting a graph area from input image data;
a second extractor for extracting, from an area excluding said graph area in said input image data, sets of color included in the area and a piece of information indicated by the color;
an identifying unit for identifying, among graph elements included in said graph area, the graph element having the same color as each of the colors included in the extracted sets;
a determining unit for determining in which positions of said graph area the pieces of information, indicated by the respective colors that the identified graph elements have, are to be added; and
an output unit for outputting output image data by adding the pieces of information indicated by the respective colors to said input image data, based on the determined positions.

2. The image processing apparatus according to claim 1, wherein
said second extractor searches a text area existing within a predetermined range with respect to said graph area in said input image data, and extracts a color included in the searched text area and a corresponding text image.

3. The image processing apparatus according to claim 1, wherein
said sets each include a color of a legend and a text image corresponding to the color of the legend.

4. The image processing apparatus according to claim 1, wherein
said output unit includes:
a generator for generating additional image data to be added to said input image data, and
a synthesizer for synthesizing said input image data and said additional image data into said output image data; and
said generator generates said additional image data by arranging said text image in a position of the corresponding graph element.

5. The image processing apparatus according to claim 4, wherein
said generator
when a circular graph is included in said graph area, determines whether or not said text image can be arranged within an area of the corresponding graph element, and
when said text image cannot be arranged within the area of the corresponding graph element, arranges the text image outside the area of the corresponding graph element.

6. The image processing apparatus according to claim 5, wherein
when said text image can be arranged within the area of the corresponding graph element, said generator changes a color of the text image to be arranged in accordance with the color of the graph element as the arrangement destination.

7. The image processing apparatus according to claim 1, wherein
when a line graph is included in said graph area, said determining unit searches a start point and an end point of each of the graph elements, and a cross point between the graph elements, and determines at least one of the start point, the end point, and a point at a predetermined distance from the cross point, as an arrangement position of the corresponding text image.

8. An image processing method comprising the steps of:
extracting a graph area from input image data;
extracting, from an area excluding said graph area in said input image data, sets of color included in the area and a piece of information indicated by the color;
identifying, among graph elements included in said graph area, the graph element having the same color as each of the colors included in the extracted set;
determining a position where the piece of information, indicated by the respective colors that the identified graph elements have, are to be added in said graph area; and
outputting output image data by adding the pieces of information indicated by the respective colors to said input image data, based on the determined positions.

9. The image processing method according to claim 8, wherein
the step of extracting said sets includes the steps of:
searching a text area existing within a predetermined range with respect to said graph area in said input image data, and
extracting a color included in the searched text area and a corresponding text image.

10. The image processing method according to claim 8, wherein
said sets each include a color of a legend and a text image corresponding to the color of the legend.

11. The image processing method according to claim 8, wherein
the step of outputting includes the steps of:
generating additional image data to be added to said input image data; and
synthesizing said input image data and said additional image data into said output image data, and
said step of generating includes the step of generating said additional image data by arranging said text image in a position of the corresponding graph element.

12. The image processing method according to claim 11, wherein
the step of generating further includes the steps of:
determining whether or not said text image can be arranged within an area of the corresponding graph element when a circular graph is included in said graph area; and
arranging the text image outside the area of the corresponding graph element when said text image cannot be arranged within the area of the corresponding graph element.

13. The image processing method according to claim 12, wherein
the step of generating further includes the step of changing a color of said text image to be arranged in accordance with the color of the graph element as the arrangement destination, when the text image can be arranged within the area of the corresponding graph element.

14. The image processing method according to claim 8, wherein
the step of determining includes the steps of:
when a line graph is included in said graph area,
searching a start point and an end point of each of the graph elements, and a cross point between the graph elements; and
determining at least one of the start point, the end point, and a point at a predetermined distance from the cross point, as an arrangement position of the corresponding text image.

15. A storage medium storing an image processing program, when said image processing program is executed by a processor, said image processing program causes the processor operative to:
extract a graph area from input image data;
extract from an area excluding said graph area in said input image data, sets of color included in the area and a piece of information indicated by the color;
identify, among graph elements included in said graph area, the graph element having the same color as each of the colors included in the extracted set;
determine a position where the piece of information, indicated by the respective colors that the identified graph elements have, are to be added in said graph area; and
output output image data by adding the piece of information indicated by the respective colors to said input image data, based on the determined positions.

16. The storage medium storing the image processing program according to claim 15, wherein
the extracting said sets includes:
searching a text area existing within a predetermined range with respect to said graph area in said input image data, and
extracting a color included in the searched text area and a corresponding text image.

17. The storage medium storing the image processing program according to claim 15, wherein
said sets each include a color of a legend and a text image corresponding to the color of the legend.

18. The storage medium storing the image processing program according to claim 15, wherein
the outputting includes:
generating additional image data to be added to said input image data; and
synthesizing said input image data and said additional image data into said output image data, and
the generating includes generating said additional image data by arranging said text image in a position of the corresponding graph element.

19. The storage medium storing the image processing program according to claim 18, wherein
the generating further includes,
determining whether or not said text image can be arranged within an area of the corresponding graph element when a circular graph is included in said graph area; and
arranging the text image outside the area of the corresponding graph element when said text image cannot be arranged within the area of the corresponding graph element.

20. The storage medium storing the image processing program according to claim 19, wherein
the generating further includes changing a color of said text image to be arranged in accordance with the color of the graph element as the arrangement destination, when the text image can be arranged within the area of the corresponding graph element.

21. The storage medium storing the image processing program according to claim 15, wherein
the determining includes:
when a line graph is included in said graph area,
searching a start point and an end point of each of the graph elements, and a cross point between the graph elements; and
determining at least one of the start point, the end point, and a point a predetermined distance from the cross point, as an arrangement position of the corresponding text image.
